(19) United States
(12) Patent Application Publication
(10) Pub. No.: US 2018/0374094 A1
(43) Pub. Date: Dec. 27, 2018

(54) METHOD AND SYSTEM FOR INDEXING CONSUMER ENROLLMENT USING BLOCKCHAIN

(71) Applicant: Mastercard International Incorporated, Purchase, NY (US)

(72) Inventor: Manoneet KOHLI, O'Fallon, MO (US)

(73) Assignee: Mastercard International Incorporated, Purchase, NY (US)

(21) Appl. No.: 15/629,837

(22) Filed: Jun. 22, 2017

(51) Int. Cl. G06Q 20/40; G06Q 20/06; G06F 17/30; G06Q 20/38

(52) U.S. Cl. CPC G06Q 20/401; G06Q 20/065; G06Q 20/3827; G06Q 20/3825; G06F 17/30377

(57) ABSTRACT

A method for indexing consumer enrollment via blockchain includes: storing a blockchain comprised of a plurality of blocks, each comprised of a block header and one or more data values, wherein the data values included in a most recent block includes at least one data point associated with a transaction account; receiving an update request from a computing device including updated data points associated with the transaction account, wherein at least one of the updated data points has a different value from the at least one data point; generating a new block header comprised of a timestamp, reference value associated with the block header comprising the most recent block, and a reference value associated with the updated data points; generating a new block comprised of the new block header and the updated data points; validating the new block; and transmitting the new block to one or more external computing systems.

### FIELD

The present disclosure relates to the indexing of consumer enrollment using blockchain, specifically the use of a blockchain to update consumer enrollment details to provide for instant and wide distribution of changes in consumer data using an immutable and independently verifiable platform.

### BACKGROUND

When a consumer enrolls in a service, such as a utility, a subscription for a product, etc., they often have to provide a number of details about themselves, such as name, address, telephone number, contact information, etc. In cases where a recurring payment may be part of enrollment, the consumer may also have to provide payment credentials associated with a transaction account to be used to fund such payments. In instances where a consumer may be registered with a number of utilities and utilize a large amount of subscription services, when the consumer's information changes, the consumer may be required to update their information with a large number of entities. The process may be increasingly difficult when changes occur to a transaction account, as changes with entities may have to be performed quickly due to payment due dates.

Currently, there are no methods and systems that can assist a consumer in providing updates to their enrollment to multiple entities. As a result, when changes occur for a consumer, they must individually approach each entity with which they are enrolled and manually update their data therewith. In some instances, the consumer may want to provide their data to a third party, which may be able to assist by contacting the entities with which the consumer is enrolled. However, the lack of services available for notifying multiple entities at once requires the third party entity to manually contact each entity with which the consumer is enrolled individually, still resulting in a laborious and time consuming process.

Thus, there is a need for a technical solution whereby a plurality of entities can be informed of updates and changes in consumer enrollment at the same time, providing for more efficiency and an accurate updating of consumer information.

### SUMMARY

The present disclosure provides a description of systems and methods for the indexing of consumer enrollment using blockchain. The use of a blockchain can ensure that updated consumer enrollment data is widely available to any authorized entity, enabling a consumer to update every entity with which they are enrolled all at the same time. In addition, the immutability of the blockchain can ensure that all of the consumer's data is accurate and cannot be changed, while also enabling the entities with which the consumer is enrolled to independently validate the data stored therein. Furthermore, if the entities with which the consumer is enrolled operate as blockchain nodes, the entities will be automatically identified of changes in the consumer enrollment information, not only providing for a wide update of consumer data, but also notifying every entity when such an update does occur.

A method for indexing consumer enrollment via blockchain includes: storing, in a memory of a computing node, a blockchain comprised of a plurality of blocks, wherein each block is comprised of at least a block header and one or more data values, wherein the one or more data values included in a most recent block includes at least one data point associated with a transaction account; receiving, by a receiving device of the computing node, an update request from a computing device, wherein the update request includes one or more updated data points associated with the transaction account, wherein at least one of the one or more updated data points has a different value from the at least one data point; generating, by a generation module of the computing node, a new block header comprised of at least a timestamp, a reference value associated with the block header comprising the most recent block, and a reference value associated with the one or more updated data points; generating, by the generation module of the computing node, a new block comprised of at least the generated new block header and the one or more updated data points; validating, by a validation module of the computing node, the generated new block; and electronically transmitting, by a transmitting device of the computing node, at least the new block to one or more external computing systems.

A system for indexing consumer enrollment via blockchain includes: a memory of a computing node configured to store a blockchain comprised of a plurality of blocks, wherein each block is comprised of at least a block header and one or more data values, wherein the one or more data values included in a most recent block includes at least one data point associated with a transaction account; a receiving device of the computing node is configured to receive an update request from a computing device, wherein the update request includes one or more updated data points associated with the transaction account, wherein at least one of the one or more updated data points has a different value from the at least one data point; a generation module of the computing node is configured to generate a new block header comprised of at least a timestamp, a reference value associated with the block header comprising the most recent block, and a reference value associated with the one or more updated data points, and generate a new block comprised of at least the generated new block header and the one or more updated data points; a validation module of the computing node is configured to validate the generated new block; and a transmitting device of the computing node is configured to electronically transmit at least the new block to one or more external computing systems.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the indexing of consumer enrollment using blockchain in accordance with exemplary embodiments.

FIG. 2 is a block diagram illustrating the computing node of the system of FIG. 1 for the indexing of consumer enrollment using blockchain in accordance with exemplary embodiments.

FIG. 3 is a flow diagram illustrating a process for the indexing of consumer enrollment using blockchain in the system of FIG. 1 in accordance with exemplary embodiments.

FIG. 4 is a flow chart illustrating an exemplary method for indexing consumer enrollment using blockchain in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Indexing Consumer Enrollment

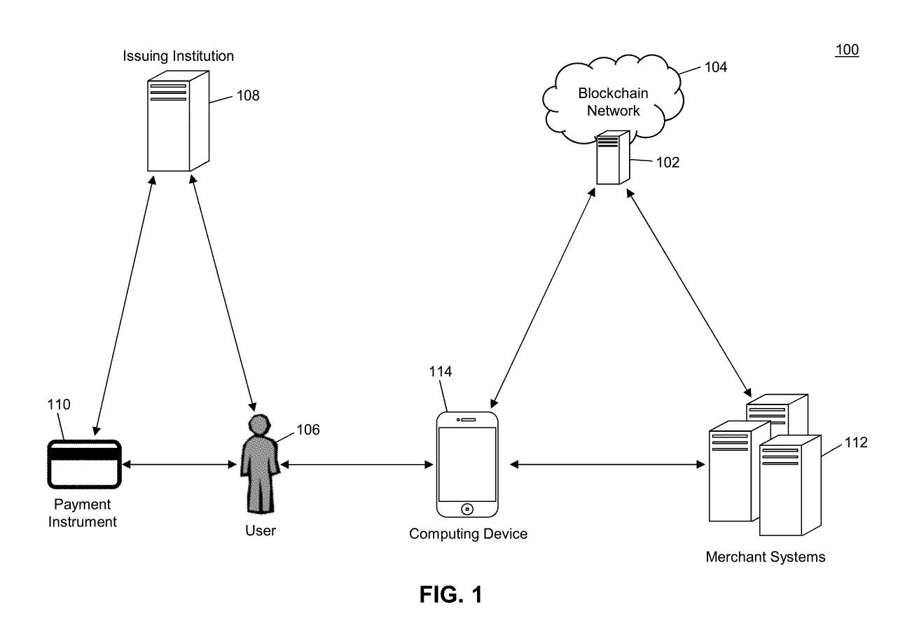

FIG. 1 illustrates a system 100 for the indexing of consumer enrollment and automatic updating of consumer enrollment information with multiple entities using a blockchain.

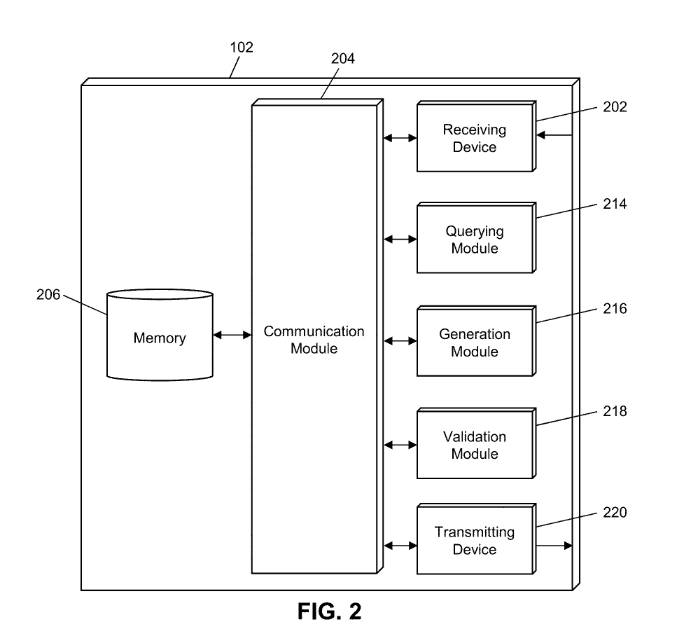

The system 100 may include a computing node 102. The computing node 102 may be one of a plurality of nodes comprising a blockchain network 104. The blockchain network 104 may be associated with one or more blockchains, which may be used to store data associated with consumer enrollment across a plurality of different merchants or other entities. The computing node 102 may be configured to generate and validate new blocks that are added to the blockchain, where the validation process for a new block may involve mathematical verification of data stored therein across a plurality of the nodes comprising the blockchain network 104. The computing node 102, discussed in more detail below with respect to FIG. 2, may be configured to obtain consumer enrollment data, store such data in a new block that is generated and added to the blockchain, and, in some cases, may notify merchants or other entities of the updating of the consumer enrollment information.

In the system 100, a user 106 may be enrolled with one or more merchants or other entities. As referred to herein, a “merchant” may refer to any entity with which the user 106 is enrolled in a service or otherwise provides information thereto that is associated with the user 106, such as contact information, transaction account information, or other such data that may be updated where the entity may need to be informed of such an update. For instance, the entity may be a utility, financial institution, service provider, etc. As part of the user's enrollment with the merchants, the user 106 may provide such enrollment information thereto.

In some embodiments, the user 106 may provide transaction account information as part of their enrollment with a merchant. In such an embodiment, the system 100 may include an issuing institution 108. The issuing institution 108 may be a financial institution, such as an issuing bank, or other suitable entity that is configured to issue a transaction account to the user 106 for use in funding payment transactions. The issuing institution 108 may issue a transaction account to the user 106 and, as part of the issuing of the transaction account, may issue a payment instrument 110 to the user 106. The payment instrument 110 may be, for instance, a credit card, virtual payment card, check, etc. The payment instrument 110 may be encoded with, include, or be otherwise associated with payment credentials corresponding to the related transaction account. The payment credentials may include any data that must be communicate as part of a transaction process for the transaction to be funded via the related transaction account, such as a primary account number, expiration date, and security code. In these embodiments, the user 106 may provide the payment credentials to a merchant as part of their enrollment, such as to be used in a recurring transaction (e.g., for a subscription service) or any time a payment is made (e.g., payment details saved for future purchases).

Traditionally, when the user 106 enrolls with a merchant, they may provide their enrollment information to a merchant system 112 associated therewith. The merchant system 112 may be a computing system associated with the merchant used to receive and store consumer enrollment information. In such cases, the user 106 may provide their enrollment information directly to the merchant system 112 (e.g., entry at a kiosk at the merchant), through a third party (e.g., direct communication to an employee of the merchant for entry into the merchant system 112), via a computing device 114 (e.g., through a website, application program, or other interface associated with the merchant system 112), or other suitable method. The merchant system 112 may receive and store the enrollment information associated with the user 106. In traditional systems, for the user 106 to update their information, they would once again have to manually interact with the merchant system 112, which may be exceedingly time consuming and difficult when multiple merchants are involved, and even more so if the merchant system 112 lacks a suitable interface for interaction via the computing device 114.

In the system 100, to update their enrollment information with each merchant, the user 106 may provide their update enrollment details to the computing node 102. The user 106 may use the computing device 114 to submit their updated enrollment data to the computing node 102 using a suitable interface provided thereby (e.g., a web page, application program, application programming interface, etc.). For instance, the computing device 114 may be navigated to a web page that includes a form that may be filled out by the user 106 to submit their updated enrollment information to the computing node 102. The computing node 102 may receive the consumer enrollment information, and may then proceed to add the enrollment information to the blockchain associated with the blockchain network 104. In some embodiments, the computing node 102 may receive the update information from a merchant or other entity. For instance, the user 106 may update their enrollment information with a merchant directly, who may provide the updated enrollment details to the computing node 102 for posting to the blockchain.

The blockchain may be comprised of a plurality of blocks, where each block is comprised of a block header and one or more data values. The data values may each be associated with enrollment information provided by the user 106, and may include, for instance, the updated enrollment information, indications as to what data fields/values are updated, processes used to validate the updated information, etc. In some cases, a single blockchain may be directly associated with only a single user 106, where all data values included therein may be associated with the user's enrollment information. In other cases, the enrollment information may be stored in the blockchain along with information identifying the user 106, such as an identification number, username, e-mail address, telephone number, tax identification number, or other suitable value, including a blockchain address, as discussed in more detail below. Each block header may include at least a timestamp, a block reference value, and a data reference value. The timestamp may be a stamp of a time when the block header is generated. The block reference value may be a reference to the previous block (e.g., determined via timestamp) in the blockchain. In some cases, the block reference value may be a hash value generated via the application of one or more hashing algorithms to the block header of the previous block. The data reference value may be a reference to the one or more data values included in the respective block. In some cases, the data reference value may be a hash value generated via the application of one or more hashing algorithms, which may be the same or different than those used in generation of the block reference value, to the one or more data values included in the block. The use of the reference values may ensure that the data stored in the blockchain is immutable, as a modification to any data value can be detected via generation of the data reference value, as it would thus differ from the value stored in the block header, which would, in turn result in a different block reference value for the subsequent block, which would carry on through every subsequent block. As a result, no block header or data value may be modified without requiring modification to every single subsequent block in the blockchain. As each node in the blockchain network 104 may store the blockchain, no modification to the blockchain may be performed without compromise of every single node.

The computing node 102 of the blockchain network 104 may receive the data value corresponding to the updated consumer enrollment from the user 106, which may be included in a newly generated block (e.g., and incorporated into the data reference value in the respective block header). The generated block may be validated by other nodes in the blockchain network 104 using traditional methods, which may include independent generation of the reference values and validation thereof. Once validation is completed, the newly generated block may be added to the blockchain and provisioned to all of the nodes in the blockchain network 104. In some embodiments, validation of the data prior to addition of the new block may include authentication of the user 106. In some instances, authentication may be performed via a password or other unique value(s) provided by the user 106 for authentication thereof. In other instances, the blockchain network 104 may provision a private key to the user 106 of a cryptographic key pair. In such an instance, the user 106 may generate a digital signature using their private key, which may be submitted to the computing node 102 with their updated enrollment information. In these instances, the computing node 102 may validate the digital signature using the corresponding public key and associated signature validation algorithms to authenticate the updated enrollment data. In some cases, the other nodes comprising the blockchain network 104 may also validate the digital signature as part of the validation process before confirming a new block for addition to the blockchain.

Once the updated enrollment information is added to the blockchain, the merchant systems 112 may be notified. In one embodiment, the user 106 may register merchant systems 112 that are to be notified with the computing node 102, such as by providing contact information (e.g., merchant name, e-mail address, uniform resource locator, internet protocol address, etc.) for each merchant system 112 with which the user 106 is enrolled. In another embodiment, each of the merchant systems 112 may be a node in the blockchain network 104. In such an embodiment, each merchant system 112 may be provided with the newly generated block as part of the confirmation process for the block, and/or for updating of the blockchain once the new block has been confirmed. In such an embodiment, each merchant system 112 may be automatically notified of the change to the consumer enrollment via the receipt of the new block. Once the merchant system 112 has received the updated information, the merchant system 112 may update their records associated with the user 106 accordingly. In some embodiments, the merchant system 112 may submit a notification to the computing node 102 (or directly to the blockchain network 104 in instances where the merchant system 112 is a node) for the addition of a new data value to the blockchain that indicates that the merchant system 112 successfully updated the consumer's enrollment information. In such embodiments, the user 106 may be notified of the update via the new data value on the blockchain. In these embodiments, the new data value may be used for future auditing as it is a time-stamped entry that proves the merchant system 112 received and updated the user enrollment information at that time.

In some embodiments, the blockchain may be a private or permissioned blockchain. In such embodiments, only authorized entities (e.g., the merchant systems 112 and nodes) may have access to the data stored in the blockchain. In these embodiments, access may be limited to the authorized entities using any suitable method, such as being stored in a private network or location, being encrypted, etc. In cases where one blockchain may be used to store data for multiple different users 106, the enrollment information may be stored in an encrypted format, where only authorized merchant systems 112 may be provided with keys suitable for decryption of the enrollment information.

The methods and systems discussed herein may enable the user 106 to update their enrollment information with a plurality of different merchants all at the same time, and without requiring the user 106 to contact any of the merchants involved. The computing node 102 may utilize a blockchain to store and update the enrollment information, such that the data is accurate and immutable, which may prevent tampering of the data and may also provide additional benefits, such as auditability (e.g., proof of dates when data was changed or updated). In addition, the data may be independently verifiable by merchant systems 112 via the use of the blockchain and the ability to validate the reference values stored therein, to ensure accuracy of the updated enrollment information. In cases where merchant systems 112 may be nodes in the blockchain network 104, the merchant systems 112 may also be automatically notified of new updates to the enrollment information right when they are submitted by the user 106 as part of the confirmation process of new blocks. As a result, the system 100 may provide for significantly faster and more efficient updating of consumer enrollment information via the use of a blockchain, which may provide the user 106 with significantly greater convenience.

### Computing Node

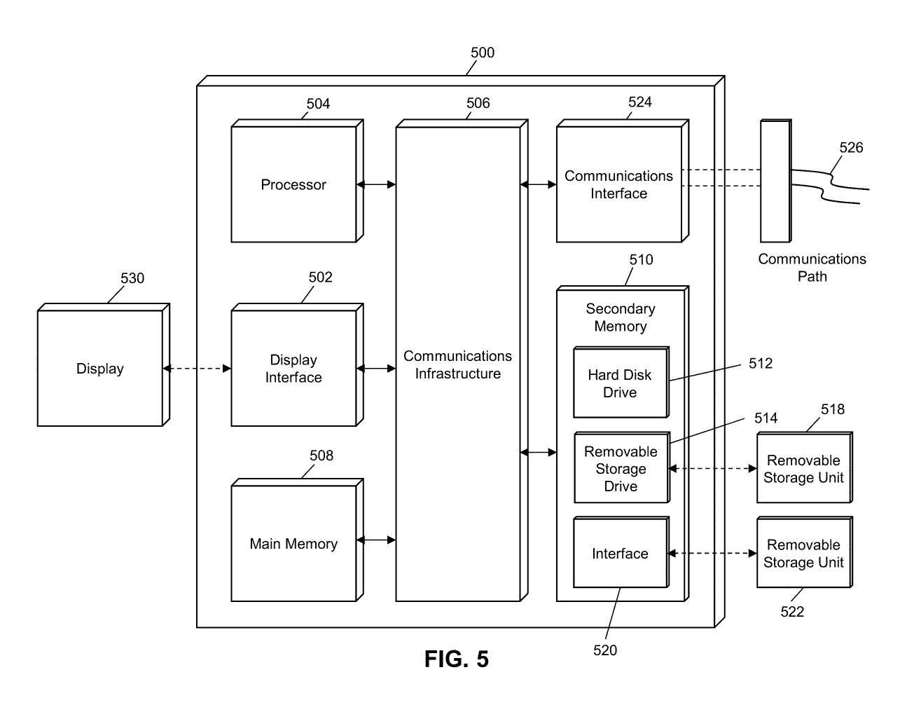

FIG. 2 illustrates an embodiment of a computing node 102 in the system 100. It will be apparent to persons having skill in the relevant art that the embodiment of the computing node 102 illustrated in FIG. 2 is provided as illustration only and may not be exhaustive to all possible configurations of the computing node 102 suitable for performing the functions as discussed herein. For example, the computer system 500 illustrated in FIG. 5 and discussed in more detail below may be a suitable configuration of the computing node 102.

The computing node 102 may include a receiving device 202. The receiving device 202 may be configured to receive data over one or more networks via one or more network protocols. In some instances, the receiving device 202 may be configured to receive data from merchant systems 112, computing devices 114, other nodes in the blockchain network 104, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by computing devices 114, which may be superimposed or otherwise encoded with updated enrollment information. In some cases, the updated enrollment information may be accompanied by authentication information to authenticate the user 106 as the source of the data, which may, in some instances, include a digital signature generated via a private key associated with the user 106. The receiving device 202 may also be configured to receive data signals electronically transmitted by other nodes in the blockchain network 104, including merchant systems 112, as applicable, which may be superimposed or otherwise encoded with confirmation messages for confirming newly generated blocks for addition to the blockchain. In some instances, the receiving device 202 may be configured to receive data signals electronically transmitted by computing devices 114 or merchant systems 112, which may be superimposed or otherwise encoded with data for registration of a merchant system 112 as an authorized recipient of updates to consumer enrollment information.

The computing node 102 may also include a communication module 204. The communication module 204 may be configured to transmit data between modules, engines, databases, memories, and other components of the computing node 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing node 102 and external components of the computing node 102, such as externally connected databases, display devices, input devices, etc. The computing node 102 may also include a processing device. The processing device may be configured to perform the functions of the computing node 102 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, validation module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The computing node 102 may include a memory 206. The memory 206 may be configured to store data for use by the computing node 102 in performing the functions discussed herein, such as public and private keys, symmetric keys, etc. The memory 206 may be configured to store data using suitable data formatting methods and schema and may be any suitable type of memory, such as read-only memory, random access memory, etc. The memory 206 may include, for example, encryption keys and algorithms, communication protocols and standards, data formatting standards and protocols, program code for modules and application programs of the processing device, and other data that may be suitable for use by the computing node 102 in the performance of the functions disclosed herein as will be apparent to persons having skill in the relevant art. In some embodiments, the memory 206 may be comprised of or may otherwise include a relational database that utilizes structured query language for the storage, identification, modifying, updating, accessing, etc. of structured data sets stored therein.

The memory 206 may be configured to store a blockchain. As discussed above, the blockchain may be comprised of a plurality of blocks, where each block may be comprised of at least a block header and one or more data values. Each block header may include a time stamp, a block reference value referring to the preceding block in the blockchain, and a data reference value referring to the one or more data values included in the respective block. The memory may also be configured to store any additional data that may be used by the computing node 102 in performing the functions discussed herein, such as hashing algorithms for generating reference values for the blockchain, communication data for communicating with other blockchain nodes and other computing devices, access data for providing access to merchant systems 112 to blockchain data, public keys corresponding to private keys provisioned to users 106 for verification of digital signatures, etc.

The computing node 102 may include a querying module 214. The querying module 214 may be configured to execute queries on databases to identify information. The querying module 214 may receive one or more data values or query strings, and may execute a query string based thereon on an indicated database, such as the memory 206, to identify information stored therein. The querying module 214 may then output the identified information to an appropriate engine or module of the computing node 102 as necessary. The querying module 214 may, for example, execute a query on the memory 206 to identify a the most recent block added to the blockchain (e.g., based on timestamp) as part of the process in generating a new block, or may execute a query on the memory 206 to identify a public key corresponding to the user 106 for use in validating a digital signature provided with updated enrollment information for authentication thereof.

The computing node 102 may also include a generation module 216. The generation module 216 may be configured to generate data for the computing node 102 for use in performing the functions discussed herein. The generation module 216 may receive instructions as input, may generate data based on the instructions, and may output the generated data to one or more modules or engines of the computing node 102. For example, the generation module 216 may be configured to generate new blocks and new block headers for confirmation and addition into the blockchain. The generation module 216 may also be configured to generate notifications regarding the updating of enrollment information for submission to merchant systems 112, as well as for providing to users 106 (e.g., via associated computing devices 114) to inform the user 106 that their enrollment information has been successfully update. The generation module 216 may also be configured to generate hash values via the application of hashing algorithms to data, such as for the generation of reference values to be included in the block header of a newly generated block. In some cases, the generation of hash values may be performed via a separate hashing module included in the computing node 102.

The computing node 102 may also include a validation module 218. The validation module 218 may be configured to validate data for the computing node 102 for use in performing the functions discussed herein. The validation module 218 may receive instructions as input, may validate data as instructed, and may output a result of the validation to another module or engine of the computing node 102. For example, the validation module 218 may be configured to validate digital signatures to authenticate the source of updated enrollment information, validate newly generated blocks (e.g., by confirming reference values), validate a request for access to blockchain data (e.g., submitted by a merchant system 112), etc.

The computing node 102 may also include a transmitting device 220. The transmitting device 220 may be configured to transmit data over one or more networks via one or more network protocols. In some instances, the transmitting device 220 may be configured to transmit data to merchant systems 112, computing devices 114, other nodes in the blockchain network 104, and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to other nodes in the blockchain network 104, including merchant systems 112, as applicable, that are superimposed or otherwise encoded with newly generated blocks for validation and confirmation thereof. The transmitting device 220 may also be configured to electronically transmit data signals superimposed or otherwise encoded with confirmed blocks to merchant systems 112 for the updating of consumer enrollment information. In some instances, the transmitting device 220 may be configured to electronically transmit data signals to computing devices 114, which may be superimposed or otherwise encoded with notifications regarding the updating of consumer enrollment information (e.g., the successful generation of a new block, successful notifying of a merchant system 112 of the update, etc.). In some embodiments, the transmitting device 220 may be configured to electronically transmit data signals to computing devices 114 for the provisioning of a cryptographic key pair thereto for use in generating digital signatures for use during submissions of updated consumer enrollment information.

### Process for Indexing of Consumer Enrollment Via Blockchain

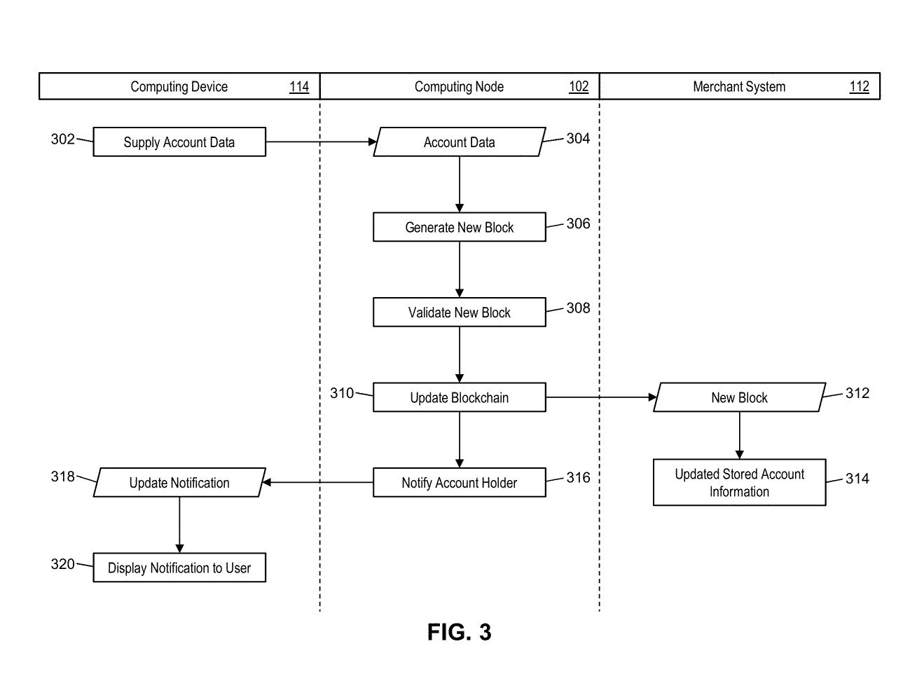

FIG. 3 illustrates a process for the indexing of consumer enrollment in a blockchain in the system 100 for the updating of consumer enrollment information associated with the user 106 across a plurality of merchant systems 112.

In step 302, the computing device 114, as operated by the user 106, may submit new data associated with their transaction account (e.g., or other consumer enrollment information) to the computing node 102 using a suitable interface associated therewith. In step 304, the receiving device 202 of the computing node 102 may receive the updated account data. In some cases, the account data may be accompanied by a digital signature or other authentication information. In such cases, the validation module 218 of the computing node 102 may validate the authentication information upon receipt to ensure the authenticity of the computing device 114 and the data submitted thereby.

In step 306, the generation module 216 of the computing node 102 may generate a new block for addition to the blockchain. The new block may be comprised of at least a block header and one or more data values, wherein the one or more data values includes the updated account data received from the computing device 114. In cases where the blockchain may be associated with only the user 106, the one or more data values may only include data submitted by the user 106 as authenticated by the validation module 218 of the computing node 102. The block header of the new block may include at least a timestamp, a transaction reference value associated with the one or more data values, and a block reference value associated with the most recent block that was previously added to the blockchain. In some embodiments, the reference values may be hash values generated via the application of one or more hashing algorithms to the respective data. In some cases, the computing node 102 may encrypt the one or more data values prior to the generation of the new block.

In step 308, the computing node 102 may validate the new block. Validation of the new block may include validation of the reference values, such as by computing new reference values using the respective data and corresponding hashing algorithm(s) to ensure that the correct values were previously identified. Validation of the new block may also include electronic transmission of the new block, by the transmitting device 220 of the computing node 102, to a plurality of other computing nodes in the blockchain network 104, for confirmation thereby. In such cases, the computing nodes may use any suitable confirmation technique and method, such as proof of work, to confirm the newly generated block. The receiving device 202 of the computing node 102 may receive a response from one or more of the computing nodes indicating that the block is successfully confirmed to complete the validation.

In step 310, the computing node 102 may update the blockchain, such as by electronically transmitting (e.g., via the transmitting device 220 of the computing node 102) the confirmed block to each node in the blockchain network 104. As part of the updating, the transmitting device 220 of the computing node 102 may electronically transmit the new block to each merchant system 112. In some cases, each merchant system 112 that is provided the new block may have been previously registered with the computing node 102, such as by the user 106. In some instances, the user 106 may specify the merchant systems 112 to be notified of the updated account data in the submission of the updated enrollment information in step 302.

In step 312, the merchant system 112 may receive the new block that includes the updated consumer enrollment information. In instances where the enrollment information may be encrypted, the merchant system 112 may decrypt the enrollment information included in the new block using a suitable decryption key and/or method. In step 314, the merchant system 112 may update the user's enrollment information, such as by updating their stored payment credentials with new payment credentials included in the data values comprising the new block.

In step 316, the transmitting device 220 of the computing node 102 may electronically transmit a notification to the computing device 114 to notify the user 106 thereof that the merchant system 112 was successfully informed of the updated enrollment information. In step 318, the computing device 114 may receive the notification. In step 320, the notification may be displayed to the user 106 using a display device interfaced therewith, which may inform the user 106 that the merchant was successfully notified of their updated enrollment information. As a result, the user 106 may notify a plurality of different merchants of changes to their enrollment information, such as may be required if their payment instrument 110 is stolen and replaced, without having to do anything beyond submit the new enrollment information, in step 302.

### Exemplary Method for Indexing Consumer Enrollment Via Blockchain

In step 402, a blockchain comprised of a plurality of blocks may be stored in a memory (e.g., the memory 206) of a computing node (e.g., the computing node 102), wherein each block is comprised of at least a block header and one or more data values, wherein the one or more data values included in a most recent block includes at least one data point associated with a transaction account. In step 404, an update request may be received by a receiving device (e.g., the receiving device 202) of the computing node from a computing device (e.g., the computing device 114), wherein the update request includes one or more updated data points associated with the transaction account, wherein at least one of the one or more updated data points has a different value from the at least one data point. In step 406, a new block header may be generated by a generation module (e.g., the generation module 216) of the computing node, wherein the new block header is comprised of at least a timestamp, a reference value associated with the block header comprising the most recent block, and a reference value associated with the one or more updated data points.

In step 408, a new block comprised of at least the generated new block header and the one or more updated data points may be generated by the generation module of the computing node. In step 410, the generated new block may be validated by a validation module (e.g., the validation module 218) of the computing node. In step 412, at least the new block may be electronically transmitted by a transmitting device (e.g., the transmitting device 220) to one or more external computing systems (e.g., merchant systems 112).

In one embodiment, validating the generated new block may comprise: electronically transmitting, by the transmitting device of the computing node, the generated new block to a plurality of blockchain nodes associated with the blockchain; and receiving, by the receiving device of the computing node, an indication of successful validation of the generated new block from at least one of the plurality of blockchain nodes. In a further embodiment, the plurality of blockchain nodes may include the one or more external computing systems. In another further embodiment, the method 400 may also include electronically transmitting, by the transmitting device of the computing node, the received indication of successful validation to the plurality of blockchain nodes. In yet another further embodiment, the electronic transmission to the one or more external computing systems may further include the received indication of successful validation.

In some embodiments, the method 400 may further include electronically transmitting, by the transmitting device of the computing node, a notification indicating successful electronic transmission to the one or more external computing systems to a user device. In a further embodiment, the user device may be the computing device. In another further embodiment, the method 400 may also include storing, in the memory of the computing node, contact information associated with the user device, wherein the transmitting device is configured to electronically transmit the notification to the user device based on the stored contact information.

### Computer System Architecture

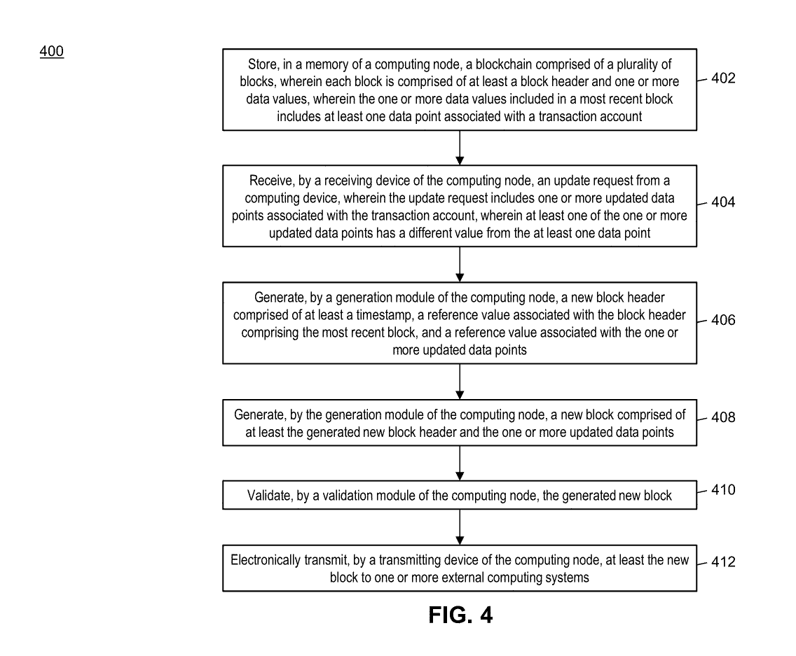

FIG. 5 illustrates a computer system 500 in which embodiments of the present disclosure, or portions thereof, may be implemented as computer-readable code. For example, the computing node 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for indexing consumer enrollment via blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for indexing consumer enrollment via blockchain, comprising:
storing, in a memory of a computing node, a blockchain comprised of a plurality of blocks, wherein each block is comprised of at least a block header and one or more data values, wherein the one or more data values included in a most recent block includes at least one data point associated with a transaction account;
receiving, by a receiving device of the computing node, an update request from a computing device, wherein the update request includes one or more updated data points associated with the transaction account, wherein at least one of the one or more updated data points has a different value from the at least one data point;
generating, by a generation module of the computing node, a new block header comprised of at least a timestamp, a reference value associated with the block header comprising the most recent block, and a reference value associated with the one or more updated data points;
generating, by the generation module of the computing node, a new block comprised of at least the generated new block header and the one or more updated data points;
validating, by a validation module of the computing node, the generated new block; and
electronically transmitting, by a transmitting device of the computing node, at least the new block to one or more external computing systems.

2. The method of claim 1, wherein validating the generated new block comprises:
electronically transmitting, by the transmitting device of the computing node, the generated new block to a plurality of blockchain nodes associated with the blockchain; and
receiving, by the receiving device of the computing node, an indication of successful validation of the generated new block from at least one of the plurality of blockchain nodes.

3. The method of claim 2, wherein the plurality of blockchain nodes includes the one or more external computing systems.

4. The method of claim 2, further comprising:
electronically transmitting, by the transmitting device of the computing node, the received indication of successful validation to the plurality of blockchain nodes.

5. The method of claim 2, wherein the electronic transmission to the one or more external computing systems further includes the received indication of successful validation.

6. The method of claim 1, further comprising:
electronically transmitting, by the transmitting device of the computing node, a notification indicating successful electronic transmission to the one or more external computing systems to a user device.

7. The method of claim 6, wherein the user device is the computing device.

8. The method of claim 6, further comprising:
storing, in the memory of the computing node, contact information associated with the user device, wherein
the transmitting device is configured to electronically transmit the notification to the user device based on the stored contact information.

9. A system for indexing consumer enrollment via blockchain, comprising:
a memory of a computing node configured to store a blockchain comprised of a plurality of blocks, wherein each block is comprised of at least a block header and one or more data values, wherein the one or more data values included in a most recent block includes at least one data point associated with a transaction account;
a receiving device of the computing node is configured to receive an update request from a computing device, wherein the update request includes one or more updated data points associated with the transaction account, wherein at least one of the one or more updated data points has a different value from the at least one data point;
a generation module of the computing node is configured to
generate a new block header comprised of at least a timestamp, a reference value associated with the block header comprising the most recent block, and a reference value associated with the one or more updated data points, and
generate a new block comprised of at least the generated new block header and the one or more updated data points;
a validation module of the computing node is configured to validate the generated new block; and
a transmitting device of the computing node is configured to electronically transmit at least the new block to one or more external computing systems.

10. The system of claim 9, wherein validating the generated new block comprises:
electronically transmitting, by the transmitting device of the computing node, the generated new block to a plurality of blockchain nodes associated with the blockchain; and
receiving, by the receiving device of the computing node, an indication of successful validation of the generated new block from at least one of the plurality of blockchain nodes.

11. The system of claim 10, wherein the plurality of blockchain nodes includes the one or more external computing systems.

12. The system of claim 10, wherein the transmitting device of the computing node is further configured to electronically transmit the received indication of successful validation to the plurality of blockchain nodes.

13. The system of claim 10, wherein the electronic transmission to the one or more external computing systems further includes the received indication of successful validation.

14. The system of claim 9, wherein the transmitting device of the computing node is further configured to electronically transmit a notification indicating successful electronic transmission to the one or more external computing systems to a user device.

15. The system of claim 14, wherein the user device is the computing device.

16. The system of claim 14, wherein
the memory of the computing node is further configured to store contact information associated with the user device, and
the transmitting device is configured to electronically transmit the notification to the user device based on the stored contact information.
